(19) United States
(12) Patent Application Publication
(10) Pub. No.: US 2006/0122922 A1
(43) Pub. Date: Jun. 8, 2006

(54) Purchase and rebate method

(75) Inventor: Harris Lowenthal, Scottsdale, AZ (US)

Correspondence Address: WEISS & MOY PC, 4204 NORTH BROWN AVENUE, SCOTTSDALE, AZ, 85251, US

(73) Assignee: Beriza, Inc.

(21) Appl. No.: 11/003,873

(22) Filed: Dec. 3, 2004

(51) Int. Cl. G06Q 40/00

(52) U.S. Cl. 705/35; 705/42

(57) ABSTRACT

A purchase and rebate method comprises the steps of facilitating a purchase by a purchaser of a good or service from a seller and allocating a percentage of the purchase price for the benefit of the seller. The purchaser's rights to the amounts so allocated will preferably depend on whether the purchaser is able to accumulate at least a minimum amount of allocated funds, and whether the purchaser may do so within a preferably pre-established period of time. Where the purchaser does not achieve the minimum allocation within the established period of time, the purchaser may preferably obtain a refund of at least a portion of the allocated amount. Where the purchaser achieves the minimum allocation within the established period of time, the allocated amount is preferably placed into a financial instrument. Thereafter, the purchaser may obtain a refund of substantially all of the allocated amount.

### FIELD OF THE INVENTION

This invention relates generally to retail purchasing methods and, more particularly, to a retail purchasing method having a rebate feature.

### BACKGROUND OF THE INVENTION

In the typical retail purchase transaction, a good or service is sold, for suitable consideration, to a purchaser. Ordinarily, consideration flows from the purchaser to the seller, rather than in the other direction.

There are some exceptions to this model. For example, the Discover® credit card provides a limited cash payment to cardholders, which is usually 2% of the price of the good or service purchased with that card. For some products, for example in the automobile and consumer electronics areas, cash rebates of some portion of the purchase price may be available.

A need exists for a system and method that creates the potential for a full return of all or substantially all of the purchase price to the purchaser. Such a system and method would permit a purchaser to, in the retail sense, have his/her cake and eat it to. In other words, under this model, the purchaser would be able to benefit from the purchase by keeping the good/service purchased, and also to obtain a full return of the purchase price. The system and method should be combined with an accredited financial instrument, so that purchasers have full comfort that, in fact, they will receive the promised refund. Other features may also be desired.

### SUMMARY OF THE INVENTION

In accordance with one embodiment of the present invention, a purchase and rebate method is disclosed. The method comprises the steps of: facilitating the purchase by a purchaser of a good or service from a seller; wherein the consideration for the purchase is a purchase price X; allocating an amount Y that is a percentage of the purchase price X for refund to the purchaser; establishing a minimum amount Z that a purchaser must accumulate through at least one purchase in order to qualify for a refund of substantially all of the purchase price X; establishing a maximum period of time in which a purchaser must accumulate the minimum amount Z; allowing a purchaser to receive a refund of a portion of the amount Y where a request for the refund is received at a time when the minimum amount Z has not been achieved within the maximum period of time; and allowing a purchaser to receive a refund of substantially all of the amount Z where a request for the refund is received at a time after the minimum amount has been achieved within the maximum period of time.

In accordance with another embodiment of the present invention, a purchase and rebate method is disclosed. The method comprises the steps of: facilitating the purchase by a purchaser of a good or service from a seller; wherein the consideration for the purchase is a purchase price X; allocating an amount Y that is a percentage of the purchase price X for refund to the purchaser; establishing a minimum amount Z that a purchaser must accumulate through at least one purchase in order to qualify for a refund of substantially all of the purchase price X; establishing a maximum period of time in which a purchaser must accumulate the minimum amount Z; allowing a purchaser to receive a refund of a portion of the amount Y where a request for the refund is received at a time when the minimum amount Z has not been achieved within the maximum period of time; wherein the portion is approximately 80%; allowing a purchaser to receive a refund of substantially all of the amount Z where a request for the refund is received at a time after the minimum amount has been achieved within the maximum period of time; where the minimum amount Z has been achieved within the maximum period of time, placing the minimum amount Z into a financial instrument; wherein the financial instrument is a tax-deferred annuity; wherein the financial instrument has a maturity period, at which time a value of the financial instrument will be at least substantially equal to the purchase price X; and allowing a purchaser to receive a refund of substantially all of the purchase price X where a request for the refund is received at a time after the maturity period of the financial instrument has been achieved.

In accordance with still another embodiment of the present invention, a purchase and rebate method is disclosed. The method comprises the steps of: facilitating the purchase by a purchaser of a good or service from a seller; wherein the consideration for the purchase is a purchase price X; allocating an amount Y that is a percentage of the purchase price X for refund to the purchaser; establishing a minimum amount Z that a purchaser must accumulate through at least one purchase in order to qualify for a refund of substantially all of the purchase price X; wherein the minimum amount Z is in the range of between approximately $3,000 and approximately $5,000; establishing a maximum period of time in which a purchaser must accumulate the minimum amount Z; wherein the maximum period of time is approximately five years; allowing a purchaser to receive a refund of a portion of the amount Y where a request for the refund is received at a time when the minimum amount Z has not been achieved within the maximum period of time; wherein the portion is approximately 80%; allowing a purchaser to receive a refund of substantially all of the amount Z where a request for the refund is received at a time after the minimum amount has been achieved within the maximum period of time; where the minimum amount Z has been achieved within the maximum period of time, placing the minimum amount Z into a financial instrument; wherein the financial instrument is a tax-deferred annuity; wherein the financial instrument has a maturity period, at which time a value of the financial instrument will be at least substantially equal to the purchase price X; and allowing a purchaser to receive a refund of substantially all of the purchase price X where a request for the refund is received at a time after the maturity period of the financial instrument has been achieved.

### BRIEF DESCRIPTION OF THE DRAWINGS

FIG. 1 is a block diagram illustrating the principal actors in a method consistent with an embodiment of the present invention, and illustrating relationships therebetween.

FIG. 2 is a flow chart illustrating a purchasing and rebate method consistent with an embodiment of the present invention.

### DETAILED DESCRIPTION OF THE PREFERRED EMBODIMENTS

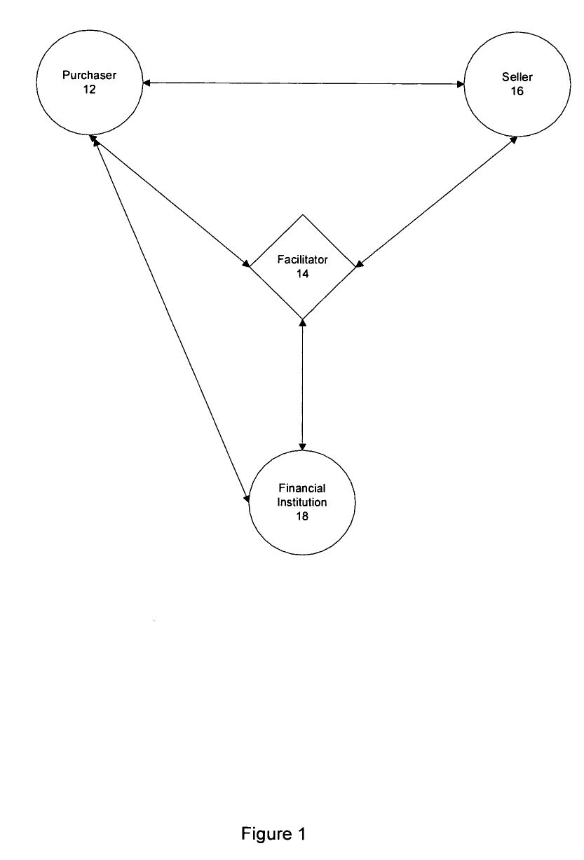

Referring first to FIG. 1, the main actors in a method consistent with an embodiment of the present invention are identified. These include purchaser 12, facilitator 14, seller 16, and financial institution 18. The roll that these actors play in the system and method of the present invention will now be illustrated.

The facilitator 14 facilitates sales transactions between a seller 16 and a purchaser 12 and the refund transaction between purchaser 12 and financial institution 18. Beginning with sales transactions, preferably, in its dealings with purchaser 12, the facilitator 14 would be electronically accessed by an Internet web-site (or like). (It should be recognized that the facilitator 14 could, optionally, be a brick and mortar site, capable of receiving purchasers 12, a call-in center or the like.) At such a site, purchasers 12 could search for items offered for sale by one or preferably a plurality of sellers 16. While it is possible that facilitator 14 could also be one or more of the sellers 16, it is preferred that the facilitator 14 restrict itself to a facilitation function as herein described. E-bay® and Amazon® would be example of entities, accessible over the Internet, that facilitate sales transactions between willing sellers and willing purchasers.

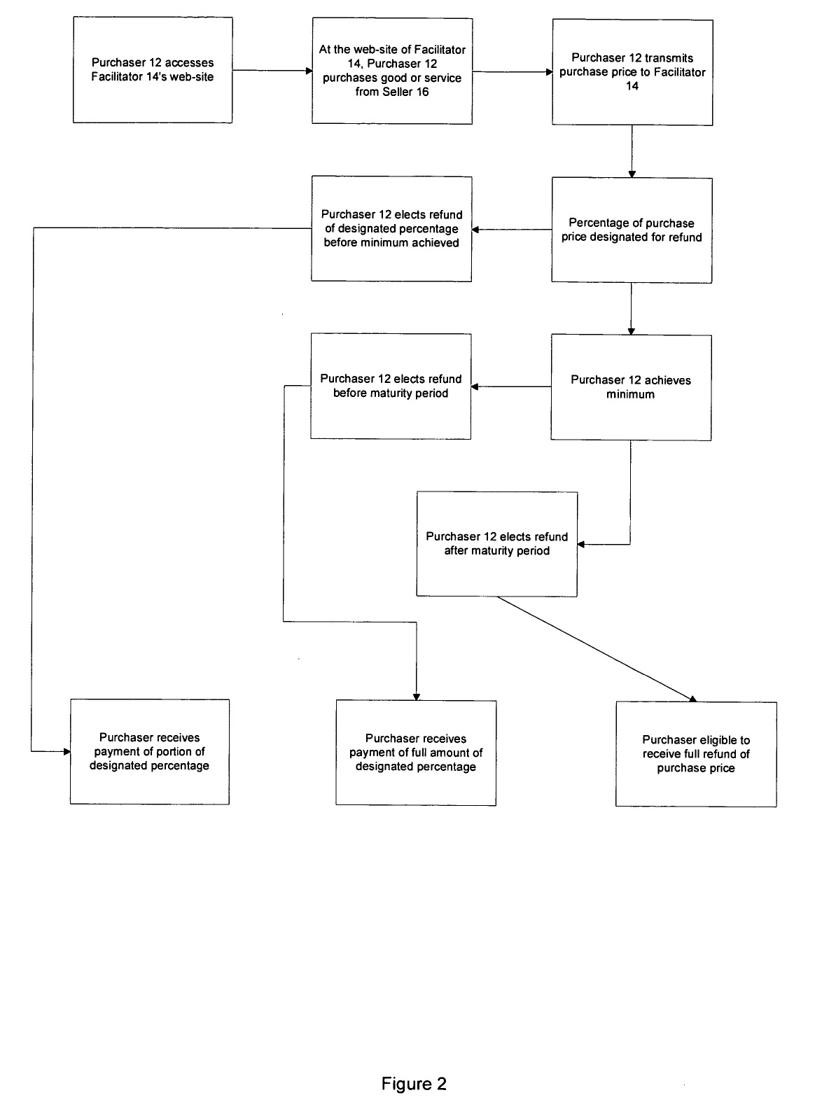

According to one embodiment, and by reference to FIG. 2, the purchase price X paid by a purchaser 12 for a good or service from a seller 16 is transmitted to the facilitator 14. Of that amount, a portion Y shall be designated for refund as herein described, and a remaining portion shall be available for other purposes, including for example payment to the seller 16, payment to the facilitator 14, and so forth. In one embodiment, the entire consideration transmitted to the facilitator 14 is first placed into a trust account or the like, over which the control of the facilitator 14 has been limited by a suitable trust instrument or the like. Payments out of the trust account shall be according to the dictates of the trust agreement. This type of structure is intended to provide increased security for purchasers 12 (for example, in the event the facilitator 14 should become insolvent), and increased confidence that the portion of the purchase price that is to be designated for refund shall in fact be so treated, and shall not be otherwise applied.

For purposes of further illustrating the system and method of the present invention, it will be assumed that portion Y represents 25% of the purchase price X paid by the purchaser 12 for a good or service from a seller 16 that will be designated for refund. (It should be recognized that this percentage, while preferred, may be varied as desired.) This description will next assume a hypothetical transaction in which a purchaser has paid $1,000 for an item from seller 16. Under this hypothetical, 25% of the purchase price, or $250, will be designated for refund.

As noted above, it may be desired to initially place the entire $1,000 purchase amount in a trust account, with $750 to be paid out to the seller 16 and/or facilitator 14 as needed. It should be noted that, initially, it may be desired to place at least the $250 amount and perhaps as much as the entire purchase amount in the trust account for the duration of any right of return or rescission period available to the purchaser 12 with respect to the good or service purchased. Currently, many items carry a thirty (30) day return right. Upon expiration of such period without exercise of such right by the purchaser 12, further disposition of the purchase amount as set forth herein would be possible.

Preferably, the facilitator 14 will establish at the outset a minimum refund amount Z that a purchaser 12 must accumulate through one or more than one purchases to be able to qualify for full refund treatment as hereinafter described. For purposes of further illustrating this embodiment, it will be assumed that this minimum Z has been established and that it is $5,000. (Preferably, the minimum Z is in the range of approximately $3,000 to $5,000, though other amounts may be selected as desired, including for example, as little as $1.) Relatedly, it is preferred that there be established a maximum period of time in which a purchaser must achieve this amount, with the period of time preferably to run from a first purchase. For example, if the $1,000 purchase is made on Jan. 1, 2005, and if the period of time is five years, the purchaser 12 will have until Jan. 1, 2010 to complete further purchases in an amount sufficient to generate a $5,000 refund amount. Continuing to assume that 25% of each purchase price receives such designation, a purchaser would need to purchase $20,000 worth of goods or services, within the five year period, to generate a $5,000 refund amount.

Preferably, each time the minimum amount Z is achieved, a new five year period should begin with the next purchase. Conversely, in the event that a purchaser 12 makes more than one purchase within a five year period, but fails to achieve the minimum amount Z, then a new five year period should be deemed to have begun with the next subsequent purchase following the expired purchase. This can be illustrated, by way of example, utilizing the information from the following table:

| Date of Purchase | Purchase Amount | Designation Amount |
|---|---|---|
| Jan. 1, 2005 | $1,000 | $250 |
| Jan. 1, 2007 | $2,000 | $500 |
| Jan. 2, 2010 | $5,000 | $1,250 |
| Jan. 1, 2011 | $13,000 | $3,250 |

According to this example, the purchaser 12 failed to achieve the $5,000 minimum within five years of the first purchase, which occurred on Jan. 1, 2005. Upon expiration of the five year period from the first purchase, that purchase may no longer be counted toward the minimum. Instead, a new calculation is made, beginning with the next purchase (which, in this example, occurred on Jan. 1, 2007). As shown in the table, the purchaser 12 did achieve the minimum within five years of the Jan. 1, 2007 purchase.

With respect to designation amounts generated by purchases, and preferably beginning immediately after the expiration any grace period necessitated by a return/rescission right with respect to the good or service purchased from seller 16, a purchaser 12 shall be permitted to request payment of a portion of the designation amounts accumulated). In one embodiment, the portion is expressed as 80% of amount Y, although it should be clearly understood that it is within the spirit and scope of this invention that the portion may deviate, even substantially, from the preferred portion in either direction.

Still proceeding with the example provided above, with respect to the Jan. 1, 2005 purchase in the amount of $1,000, the amount of $250 was designated for refund. In the event that the purchaser 12 shall request a refund before the $5,000 minimum is achieved, the purchaser 12 shall receive $200—i.e., 80% of $250. Preferably, this refund request may be made at any time after expiration of any return/rescission period relating to the good or service purchased.

With respect to the amount remaining after payment of the refund percentage ($50 in this example), there are several possibilities. That amount could be paid to a charity designated by the purchaser 12 or facilitator 14, paid to the facilitator 14, or otherwise allocated.

It is preferred that designation amounts be transmitted to the financial institution 18, for deposit into an annuity type of financial instrument. The financial instrument should be issued by an insurance company or other accredited issuer of such instruments. The instrument itself is preferably a tax-deferred annuity. (A tax deferred feature is preferred so that a purchaser 12 will not incur current tax liabilities with respect to the financial instrument prior to the running of the maturity period.) The period of time required for the amount of such an instrument to grow from the designated amounts initially paid in, which represent in this example 25% of the purchase price paid by the purchaser 12, to an amount that is equal to the original purchase price, may be established as the maturity period. Under current conditions, it is estimated that the maturity period would be approximately 20 to 25 years.

A purchaser 12 who has achieved the minimum amount (in this example $5,000) of designated payments qualifies for a full (or substantially full or perhaps more than full if the period is sufficiently long and the instrument appropriately structured) refund of the purchase price (in this example $20,000), upon completion of the maturity period. In the example set forth in the table, and assuming a 20 year maturity period, a purchaser 12 would be entitled to receive $20,000, the full amount of the purchases that generated the $5,000 minimum, on or about Jan. 1, 2031.

It may be desired to additionally provide the purchaser 12 with one or more options in addition to that of receiving a substantially full refund of the purchase price. For example, the purchaser 12 could be provided the option of applying that sum to new purchases. To incentivize such use of that sum, it may be desired to provide the purchaser 12 with enhanced purchasing power for money so applied—e.g., to allow a purchaser 12 to purchase $30,000 worth of goods or services for the $20,000 that is otherwise payable to the purchaser 12. It may also be desired to provide the purchaser 12 with the option of rolling the refund amount otherwise due into a new annuity or other financial instrument.

As illustrated in FIG. 2, between the two scenarios of a purchaser electing a refund before achieving the $5,000 minimum, and that of a purchaser achieving the minimum and waiting until the maturity period is reached, there is another alternative. A purchaser 12 who has achieved the $5,000 minimum but who thereafter decides to not wait until the end of the maturity period, may request a refund payment. Preferably, in this instance, the purchaser 12 is paid all or substantially all of the designation amount—in this example $5,000—rather than 80% of the designation amount. It may be additionally desired to pay the purchaser 12 all or a portion of interested accrued on this amount as of the refund request. On the other hand, in one embodiment, there may be a financial penalty to the purchaser 12 associated with breaking into the annuity before it reaches full maturity. For this reason, if the purchaser 12, after having achieved the $5,000 minimum does not elect to receive the full refund amount, but also does not want this amount to be placed in an annuity which may generate a financial penalty for early withdrawal, it is possible that the purchaser 12 can request that the refund amount be maintained in a trust account or some other financial instrument until the purchaser 12 designates the final disbursement of the refund amount. Alternatively, decision as to the final disbursement of the refund amount could be made by agreement with the facilitator 14, financial institution 18 or designated by the purchaser 12 in advance.

It is preferred that, with respect to payment of the refund amounts as described herein and in general with respect to issues concerning the financial instrument, the purchaser 12 and financial institution 18 communicate directly, as shown in FIG. 1. It is further preferred that payments of sums to the purchaser 12 as herein described be made by the financial institution 18 directly to the purchaser 12 (or a designated recipient selected by purchaser 12), so as to limit the amount of administrative burden placed on the facilitator 14.

While the invention has been particularly shown and described with reference to preferred embodiments thereof, it will be understood by those skilled in the art that the foregoing and other changes in form and details may be made therein without departing from the spirit and scope of the invention. For example, it should be apparent that the facilitator 14 may also be a seller 16 and/or a financial institution 18. In other words, while it is preferred that the facilitating, selling, and financial functions be divided among three entities, it may be desired to have these functions performed by two entities or even by a single entity.

I claim:

1. A purchase and rebate method comprising the steps of:
facilitating the purchase by a purchaser of a good or service from a seller;
wherein the consideration for said purchase is a purchase price X;
allocating an amount Y that is a percentage of said purchase price X for refund to said purchaser;
establishing a minimum amount Z that a purchaser must accumulate through at least one said purchase in order to qualify for a refund of substantially all of said purchase price X;
establishing a maximum period of time in which a purchaser must accumulate said minimum amount Z;
allowing a purchaser to receive a refund of a portion of said amount Y where a request for said refund is received at a time when said minimum amount Z has not been achieved within said maximum period of time; and
allowing a purchaser to receive a refund of substantially all of said amount Z where a request for said refund is received at a time after said minimum amount has been achieved within said maximum period of time.

2. The method of claim 1 further comprising the steps of:
where said minimum amount Z has been achieved within said maximum period of time, placing said minimum amount Z into a financial instrument;
wherein said financial instrument has a maturity period, at which time a value of said financial instrument will be at least substantially equal to said purchase price X; and
allowing a purchaser to receive a refund of substantially all of said purchase price X where a request for said refund is received at a time after said maturity period of said financial instrument has been achieved.

3. The method of claim 1 or 2 wherein said minimum amount Z is in the range of between approximately $3,000 and approximately $5,000.

4. The method of claim 1 or 2 wherein said minimum amount Z is approximately $5,000.

5. The method of claim 1 or 2 wherein said maximum period of time is approximately five years.

6. The method of claim 1 or 2 wherein said portion is approximately 80%.

7. The method of claim 2 wherein said financial instrument is a tax-deferred annuity.

8. A purchase and rebate method comprising the steps of:
facilitating the purchase by a purchaser of a good or service from a seller;
wherein the consideration for said purchase is a purchase price X;
allocating an amount Y that is a percentage of said purchase price X for refund to said purchaser;
establishing a minimum amount Z that a purchaser must accumulate through at least one said purchase in order to qualify for a refund of substantially all of said purchase price X;
establishing a maximum period of time in which a purchaser must accumulate said minimum amount Z;
allowing a purchaser to receive a refund of a portion of said amount Y where a request for said refund is received at a time when said minimum amount Z has not been achieved within said maximum period of time;
wherein said portion is approximately 80%;
allowing a purchaser to receive a refund of substantially all of said amount Z where a request for said refund is received at a time after said minimum amount has been achieved within said maximum period of time;
where said minimum amount Z has been achieved within said maximum period of time, placing said minimum amount Z into a financial instrument;
wherein said financial instrument is a tax-deferred annuity;
wherein said financial instrument has a maturity period, at which time a value of said financial instrument will be at least substantially equal to said purchase price X; and
allowing a purchaser to receive a refund of substantially all of said purchase price X where a request for said refund is received at a time after said maturity period of said financial instrument has been achieved.

9. The method of claim 8 wherein said minimum amount Z is in the range of between approximately $3,000 and approximately $5,000.

10. The method of claim 8 wherein said minimum amount Z is approximately $5,000.

11. The method of claim 8 wherein said maximum period of time is approximately five years.

12. A purchase and rebate method comprising the steps of:
facilitating the purchase by a purchaser of a good or service from a seller;
wherein the consideration for said purchase is a purchase price X;
allocating an amount Y that is a percentage of said purchase price X for refund to said purchaser;
establishing a minimum amount Z that a purchaser must accumulate through at least one said purchase in order to qualify for a refund of substantially all of said purchase price X;
wherein said minimum amount Z is in the range of between approximately $3,000 and approximately $5,000;
establishing a maximum period of time in which a purchaser must accumulate said minimum amount Z;
wherein said maximum period of time is approximately five years;
allowing a purchaser to receive a refund of a portion of said amount Y where a request for said refund is received at a time when said minimum amount Z has not been achieved within said maximum period of time;
wherein said portion is approximately 80%;
allowing a purchaser to receive a refund of substantially all of said amount Z where a request for said refund is received at a time after said minimum amount has been achieved within said maximum period of time;
where said minimum amount Z has been achieved within said maximum period of time, placing said minimum amount Z into a financial instrument;
wherein said financial instrument is a tax-deferred annuity;
wherein said financial instrument has a maturity period, at which time a value of said financial instrument will be at least substantially equal to said purchase price X; and
allowing a purchaser to receive a refund of substantially all of said purchase price X where a request for said refund is received at a time after said maturity period of said financial instrument has been achieved.
